(19) United States
(12) Patent Application Publication
(10) Pub. No.: US 2002/0154858 A1
(43) Pub. Date: Oct. 24, 2002

(54) Wavelength monitoring device

(76) Inventor: Hidekazu Kojima, Tokyo (JP)

Correspondence Address: KNOBBE MARTENS OLSON & BEAR LLP, 2040 MAIN STREET, FOURTEENTH FLOOR, IRVINE, CA, 91614, US

(21) Appl. No.: 10/127,073

(22) Filed: Apr. 19, 2002

(30) Foreign Application Priority Data
Apr. 24, 2001 (JP) 2001-125844

(51) Int. Cl. G02B 6/293; G02B 6/26

(52) U.S. Cl. 385/24; 385/15

(57) ABSTRACT

A wavelength monitoring device is provided with a deinterleaver for separating a multi-wavelength optical signal, comprised of densely spaced channel signals, into first and second channel signal groups each comprised of low-densely spaced channel signals in accordance with their wavelength, and two wavelength monitoring circuits for separating the first and second channel signal groups into individual channel signals, respectively. Alternatively, an optical switch for alternately monitor the first or second channel signal group is interposed between the deinterleaver and one of the wavelength monitoring circuits, with another wavelength monitoring circuit omitted.

### BACKGROUND OF THE INVENTION

1. Technical Field

The present invention relates to a wavelength monitoring device for separating a wavelength-division multiplexed optical signal, i.e., a multi-wavelength optical signal, into component channel signals and for determining a central wavelength, etc. of each channel signal.

2. Related Art

In a wavelength-division multiplexing (WDM) telecommunications system, pieces of information are carried on channel signals having different wavelength bands from one another. These channel signals are multiplexed into a multi-wavelength optical signal and delivered through optical fiber cable, whereby a large quantity of information is transmitted at high speed at a time. In a WDM telecommunications system, especially in a dense wavelength-division multiplexing (DWDM) communications system, the spacing between adjacent channels (wavelength spacing) is made narrow to increase the 1transmission capacity. If a channel signal has a wavelength component thereof falling within the wavelength band of an adjacent channel, crosstalk is caused to ruine accurate information transmission.

To obviate this, wavelength-related parameters, such as central wavelengths, of individual channel signals that constitute a multi-wavelength optical signal are monitored and results of the wavelength monitoring are provided for management of a WDM communication system. For example, a detection is made to ascertain whether the central wavelength of each channel signal deviates from a nominal wavelength, and detection results are fedback to a laser source to eliminate a wavelength deviation, if any.

Conventionally, the wavelength monitoring is implemented using a wavelength monitoring device 1 exemplarily shown in FIG. 5 that is coupled through optical couplers 3, 4 to an optical fiber 2 serving as a transmission path for multi-wavelength optical signal.

The wavelength monitoring device 1 is comprised of a wavelength monitoring circuit 5 for monitoring wavelength-related parameter values of individual channel signals, a control section 6, such as a microcomputer, for evaluating results of the wavelength monitoring, and a transmitter 7 for transmitting evaluation results through the optical fiber 1 to an external device such as a wavelength locker module, not shown. The transmitter 7 is constituted by a laser diode module (LDM), for instance. In accordance with the evaluation results, the wavelength locker module adjusts a laser source (not shown), as required, thereby adjusting a laser wavelength to a nominal wavelength. In FIG. 5, reference numerals 8 and 9 denote a display device for displaying the evaluation results and a keyboard used to manually input instruction information, etc. based on the evaluation results.

As exemplarily shown in FIG. 6, the wavelength monitoring circuit 5 comprises a wavelength-division demultiplexing filter 11 for separating a multi-wavelength optical signal into plural component channel signals, a photodetector array (PD array) 12 including plural photodetectors, such as photo-diodes (PD), each of which is adapted to receive a wavelength component of a corresponding channel signal, and an arithmetic circuit 13 for determining wavelength-related parameters, such as intensity-wavelength characteristics, of the channel signals, from electric output signals generated by the photodetectors.

As conceptually shown in FIG. 7, the demultiplexing filter 11 is designed to disperse component channel signals of a multi-wavelength optical signal onto the photodetector array 12, thereby converting a wavelength component of each channel signal into a two-dimensional position on the array 12. Thus, the arithmetic circuit 13 can determine a wavelength-intensity characteristic and a central wavelength of each channel signal, as exemplarily shown in FIG. 8, by implementing an arithmetic operation based on intensities of channel signal components detected by the photodetectors and known positions of the photodetectors on the array 12.

In order to carry out a satisfactory wavelength monitoring, however, at least three photodetectors are required for every channel signal to permit a proper detection of a wavelength-intensity characteristic of each channel signal. On the other hand, a photodetector array 12 comprised of a large number of photodetectors is difficult to fabricate without defects. In providing a photodetector array 12 capable of implementing a satisfactory wavelength monitoring, therefore, difficulties increase with the increase in the number of component channel signals of a multi-wavelength optical signal. In addition, fabrication costs of a photodetector array 12 becomes higher as the required number of photodetectors increases, and fabrication defects are liable to occur as the pitch of arranging photodetectors decreases to realize a narrow wavelength spacing between adjacent channels.

### SUMMARY OF THE INVENTION

An object of the present invention is to provide a wavelength monitoring device which is simple in construction, which is suited to monitor wavelength-related parameters of individual component channel signals of a multi-wavelength optical signal, and which is capable of meeting requirements not only for a wavelength-division multiplexing communications but also for a dense wavelength-division multiplexing communications.

According to one aspect of the present invention, a wavelength monitoring device is provided, which comprises deinterleaver means for separating a multi-wavelength optical signal comprised of densely spaced channel signals into plural channel signal groups in accordance with their wavelength, each channel signal group being comprised of low-densely spaced channel signals; and a plurality of wavelength monitoring circuits individually corresponding to the plural channel signal groups, each circuit being arranged to separate the channel signal group associated therewith into individual channel signals and detect a wavelength-related parameter of each channel signal.

The just-mentioned wavelength monitoring device is arranged to separate, as a first step, a multi-frequency optical signal into plural channel signal groups by using deinterleaver means, and then detect a wavelength-related parameter of each of channel signals obtained by separating from each channel signal group by using wavelength monitoring circuits. Accordingly, even if each wavelength monitoring circuit is configured to have a simplified construction by using a low-resolution photodetector array, the monitoring accuracy of the wavelength monitoring circuit is not lowered. Thus, a wavelength monitoring circuit can be provided, which is simple in construction and which is capable of accurately monitoring the wavelength-related parameter of each channel signal. Since the wavelength monitoring device is arranged to widen in advance, using deinterleaver means, the wavelength spacing between channel signals constituting a channel signal group to be supplied to each wavelength monitoring circuit, it is also suited to carry out the monitoring of a multi-wavelength optical signal in a DWDM telecommunications system in which channel signals are more densely spaced from one another.

According to another aspect of this invention, a wavelength monitoring device is provided, which comprises deinterleaver means for separating a multi-wavelength optical signal comprised of densely spaced channel signals into plural channel signal groups in accordance with their wavelength, each channel signal group being comprised of low-densely spaced channel signals; at least one optical switch for alternately selecting at least two channel signal groups: and at least one wavelength monitoring circuit for separating the channel signal group selected by the optical switch into individual channel signals and for detecting a wavelength-related parameter of each channel signal.

With the just-mentioned wavelength monitoring device capable of selecting an arbitrary one of at least two channel signal groups using an optical switch, it is enough to provide at least one wavelength monitoring circuit which is common to the at least two channel signal groups. This makes it possible to reduce at least by half the required number of wavelength monitoring circuits, thus simplifying the construction of the wavelength monitoring device.

### BRIEF DESCRIPTION OF THE DRAWINGS

FIG. 1 is a schematic block diagram showing a wavelength monitoring device according to a first embodiment of the present invention;

FIG. 2 is a block diagram showing in detail a deinterleaver and wavelength monitoring circuits of the wavelength monitoring device shown in FIG. 1;

FIG. 3 is a schematic block diagram showing an essential part of a wavelength monitoring device according to a modification of the present invention;

FIG. 4A is a schematic block diagram showing an essential part of a wavelength monitoring device according to a second embodiment of the present invention, in a state where the wavelength monitoring is performed in respect of one of two channel signal groups separated from a multi-wavelength optical signal;

FIG. 4B is a view, similar to FIG. 4A, showing the wavelength monitoring device in a state where the wavelength monitoring for another channel signal group is implemented;

FIG. 5 is a schematic block diagram showing a conventional wavelength monitoring device;

FIG. 6 is a block diagram exemplarily showing a wavelength monitoring circuit of the wavelength monitoring device shown in FIG. 5;

FIG. 7 is a conceptual view showing a function of a wavelength-division demultiplexing filter of the wavelength monitoring circuit shown in FIG. 6; and

FIG. 8 is a graph exemplarily showing results of the wavelength monitoring on a channel signal, implemented by the wavelength monitoring circuit shown in FIG. 6.

### DETAILED DESCRIPTION

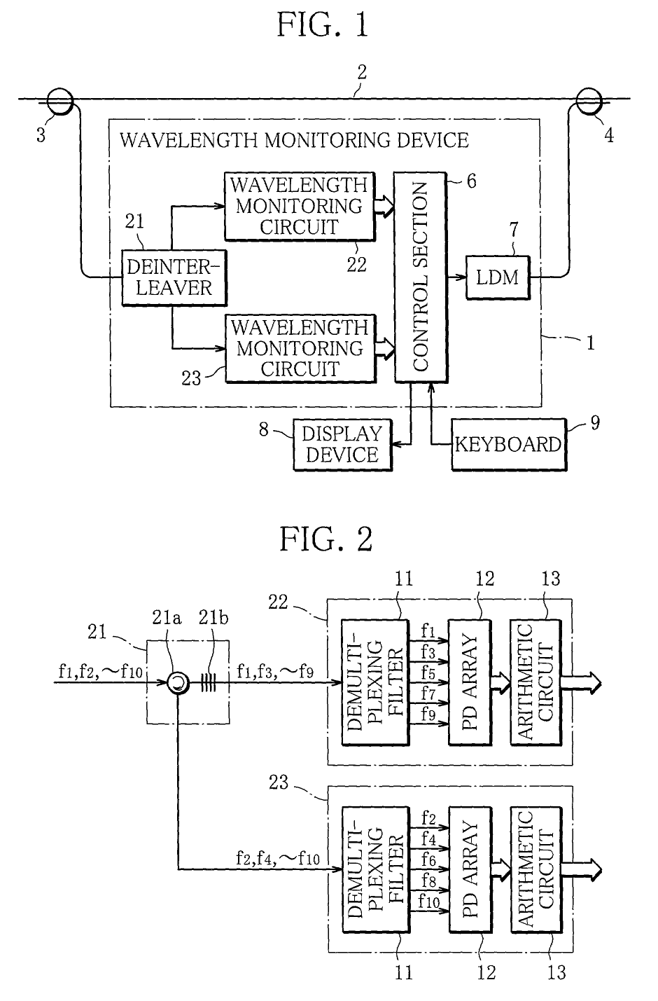

With reference to FIGS. 1 and 2, a wavelength monitoring device according to a first embodiment of the present invention will be explained. In FIG. 1, elements which are the same as those of the prior art device shown in FIG. 5 are denoted by like reference numerals.

The wavelength monitoring device of this embodiment is provided with a deinterleaver 21 for separating a multi-wavelength optical signal into plural channel signal groups. For instance, ten channel signals f1, f2, ---, f10 constituting the multi-wavelength optical signal are separated into a first channel signal group comprised of odd channel signals f1, f3, ---, f9 and a second channel signal group comprised of even channel signals f2, f4, ---, f10 in accordance with their wavelength. The wavelength monitoring device further comprises a plurality of, e.g., two wavelength monitoring circuits 22 and 23, individually corresponding to a plurality of, e.g., two channel signal groups. Each wavelength monitoring circuit serves to separates a channel signal group into individual channel signals and detect a wavelength-related parameter, such as for example, a central wavelength and intensity of each channel signal.

The deinterleaver 21 is comprised of a circulator 21a having first, second and third ports and an etalon 21b connected to the second port of the circulator 21a, and is configured to separate a multi-wavelength optical signal received at the first port of the circulator 21a into the first and second channel signal groups and deliver these channel signal groups from the etalon 21b and the third port of the circulator 21a, respectively.

As in the case of the wavelength monitoring circuit 5 of the prior art device, each of the wavelength monitoring circuits 22 and 23 is provided with a wavelength-division demultiplexing filter 11 for separating the first or second channel signal group into individual channel signals, a photodetector array 12 comprised of plural photodetector groups for receiving the separated individual channel signals, and an arithmetic circuit 13 for determining, as the wavelength-related parameter, the central signal and intensity of each channel signal in accordance with electrical signals supplied from the photodetector groups. Each photodetector group of the photodetector array (PD array) 12 is comprised of, e.g., three photodiodes (PDs) for receiving wavelength components of a corresponding one channel signal and delivering electrical output signals varying in dependence on the intensity of the channel signal.

A control section 6 of the wavelength monitoring device serves to perform the overall monitoring in respect of wavelength-related parameters for ten channel signals f1, f2, ---, f10 individually detected by the wavelength monitoring circuits 22 and 23, thereby monitoring transmission characteristics of these channel signals.

The wavelength monitoring device constructed in the above manner serves to separate a multi-wavelength optical signal into first and second channel signal groups in accordance with their wavelength and supplies these signal groups to the two wavelength monitoring circuits 22 and 23, respectively. Accordingly, the number of the channel signals that are supplied to each wavelength monitoring circuit is reduced by half as compared with ten channel signals f1, f2, ---, f10 that constitute the multi-wavelength optical signal. This enables the photodetector array 12 of each wavelength monitoring circuit 22 or 23 to receive individual channel signals with reliability to detect the intensity thereof, even if the photodetector array 12 is configured by a limited number of photodetectors.

In addition, the wavelength spacing between adjacent ones of the channel signals constituting each channel signal group separated from the multi-wavelength optical signal by means of the deinterleaver 21 is widened twice as large as that in the multi-wavelength optical signal. This permits the photodetector array 12 to make a reliable detection of wavelength-related parameters of individual channel signals, even if the photodetectors are arranged in the array 12 with a large pitch. This indicates that the wavelength-related parameter of each channel signal can be detected with ease and with reliability, thereby effectively monitoring the transmission characteristic, etc. of each channel signal, even if the wavelength spacing becomes narrower.

Furthermore, the photodetectors are not required to be arranged with a small pitch in the photodetector array 12, so that a defect-free array 12 can be realized using existing techniques. This indicates that an accurate wavelength monitoring can be realized by using a low-resolution, lowpriced photodetector array 12, even if the optical signal to be monitored is comprised of more densely separated channel signals.

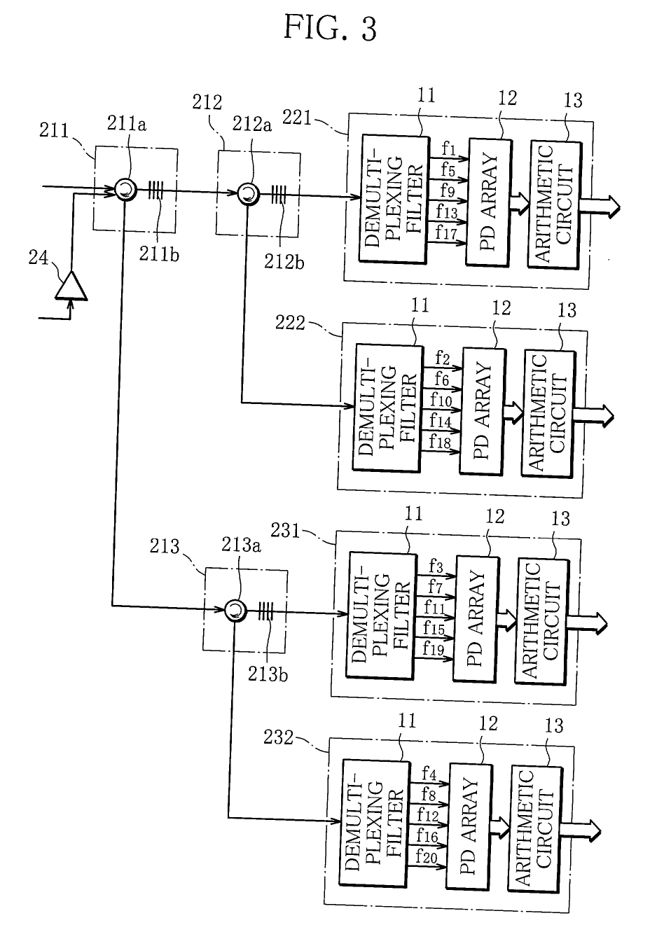

In the following, a wavelength monitoring device according to a modification of this invention will be explained with reference to FIG. 3.

The modified wavelength monitoring device is intended to implement the wavelength monitoring in respect of a multi-wavelength optical signal comprised of an increased number of channel signals, e.g., twenty channel signals f1, f2, ---, f20.

To this end, the wavelength monitoring device is provided with two-stage deinterleaver means comprised of a first deinterleaver 211 and two second deinterleavers 212, 213 and is arranged to separate the multi-wavelength optical signal into four channel signal groups. In FIG. 3, reference numerals 211a, 212a and 213a each denote a circulator corresponding to the circulator 21a shown in FIG. 2, and 211b, 212b and 213b each denote an etalon corresponding to the etalon 21b shown in FIG. 2.

The first deinterleaver 211 serves to separate a multi-wavelength optical signal received at the first port of the circulator 211a into a first channel signal group f1, f3, ---, f19 and a second channel signal group f2, f4, ---, f20 and to deliver these signal groups from the etalon 211b and the third port of the circulator 211a, respectively. The second deinterleaver 212 serves to separate the channel signal group f1, f3, ---, f19, received at the first port of the circulator 212a from the etalon 211b of the first deinterleaver 211, into two subsidiary channel groups f1, f5, ---, f17; f3, f7, ---, f19 and deliver them to first and second wavelength monitoring circuits 221, 222 from the etalon 212b and the third port of the circulator 212a, respectively. Another second deinterleaver 213 serves to separate the channel signal group f2, f4, ---, f20, received at the first port of the circulator 213a from the third port of the circulator 211a of the first deinterleaver 211, into two subsidiary channel signal groups f2, f6, ---, f18; f4, f8, ---, f20, and deliver them to third and fourth wavelength monitoring circuits 231, 232 from the etalon 213b and the third port of the circulator 213a, respectively. Each of the first through fourth wavelength monitoring circuits 221, 222, 231 and 232 is configured in the same manner as the wavelength monitoring circuits 22 and 23 shown in FIG. 2.

In FIG. 3, reference numeral 24 denotes an optical amplifier inserted into the input line of the first deinterleaver 211. The optical amplifier 24 compensates for a loss caused in the aforementioned arrangement where the two-stage deinterleaver means is comprised of the three deinterleavers 211, 212 and 213 provided at locations upstream of the wavelength monitoring circuits 221, 222, 231 and 232. Instead of providing the optical amplifier 24, optical amplifiers may be built into the deinterleavers 211, 212 and 213, respectively.

According to the modified wavelength monitoring device constructed as mentioned above, the wavelength spacing in the subsidiary channel signal group supplied to each of the wavelength monitoring circuits 221, 222, 231 and 232 is four times larger than that in the multi-wavelength optical signal, thereby sufficiently widening the wavelength spacing between channel signals supplied as detection object to a photodetector array 12 of each wavelength monitoring circuit. This permits the wavelength monitoring device to implement the wavelength monitoring with ease and with reliability, despite a doubling in the number of channels to twenty.

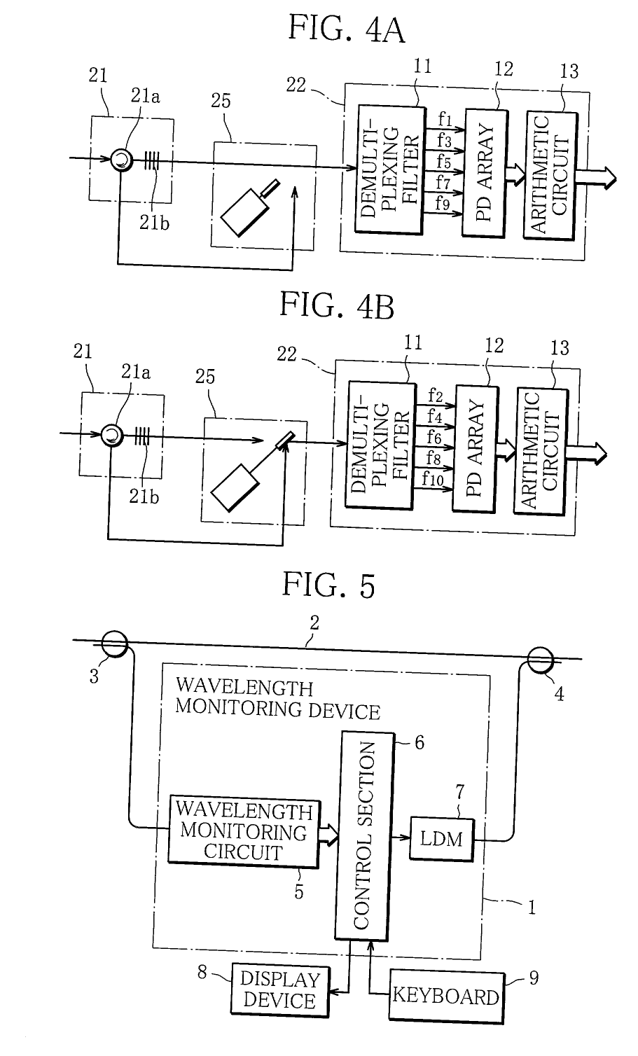

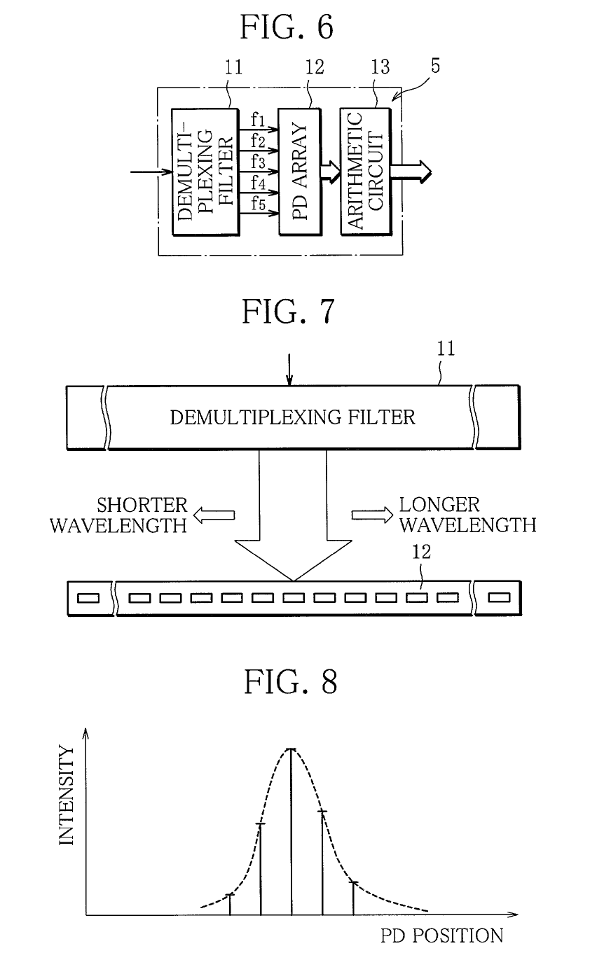

Next, a wavelength monitoring device according to a second embodiment of the present invention will be explained with reference to FIGS. 4A and 4B.

The wavelength monitoring device of this embodiment has the same basic configuration as that of the first embodiment, but differs therefrom in that the required number of wavelength monitoring circuit is reduced by half.

To this end, the wavelength monitoring device comprises an optical switch 25 that is provided on the side downstream of a deinterleaver 21 for separating a multi-wavelength signal into first and second channel signal groups. The optical switch 25 serves to alternately select the first or second channel signal group and supply the thus selected channel signal group to a wavelength monitoring circuit 22 which is common to the first and second channel signal groups. FIG. 4A illustrates a first state wherein the first channel signal group comprised of odd channel signals f1, f3, ---, f9 is selected by the optical switch 25 and supplied to the wavelength monitoring circuit 22, whereas FIG. 4B illustrates a second state wherein the second channel signal group comprised of even channel signals f2, f4, ---, f10 is selected and supplied to the circuit 22.

As explained above, the wavelength monitoring device can alternately monitor the first or second channel signal group by timesharing the wavelength monitoring circuit 22 which is common to these two channel signal groups, making it possible to reduce the required number of wavelength monitoring circuits by half, as compared to the first embodiment, thereby simplify the wavelength monitoring device in construction. The wavelength monitoring device is advantageously applied to a system that is not required to monitor the first and second channel signal groups at a time.

The present invention is not limited to the first and second embodiment and the modification, but may be modified variously.

For example, a wavelength monitoring circuit 22 or 23 has been explained that is arranged to monitor a channel signal group comprised of five channel signals. However, a channel signal group to be monitored by a wavelength monitoring circuit may be comprised of an arbitrary number of channel signals other than five. Although a photodetector array having photodetector groups each comprised of three photodetectors has been explained, each photodetector group may comprised of an arbitrary number of photodetectors other than three. With a photodetector array that is constituted by photodetector groups each comprised of an increased number of photodetectors, the monitoring accuracy can be of course improved.

Although a deinterleaver has been explained that separates a multi-wavelength optical signal into two channel signal groups or separates a channel signal group into two subsidiary channel signal groups, a deinterleaver may be arranged to separate a multi-wavelength optical signal or a channel signal group into three or more groups.

Furthermore, respective features of the first and second embodiments and the modification shown in FIGS. 1 through 4B may be combined appropriately. For example, in the wavelength monitoring circuit shown in FIG. 3, optical switches, each corresponding to the optical switch 25 shown in FIGS. 4A and 4B, may be interposed between the second deinterleaver 212 and the first wavelength monitoring circuit 221 and between the second deinterleaver 213 and the third wavelength monitoring circuit 231, respectively, with the second and fourth wavelength monitoring circuits 222, 232 omitted.

A two-stage deinterleaver means has been explained in the modification shown in FIG. 3. However, deinterleaver means may be configured by three or more deinterleaver stages. In the case of a three-stage deinterleaver, the third stage is constituted by four deinterleavers.

The deinterleaver means may be configured as an FBG (fiber bragg grating) structure other than the etalon structure shown in FIGS. 2 and 3.

Further, the deinterleaver means may be configured by an interleaver/deinterleaver of a micro-optics type where an optical multilayer and an optical crystal are combined, a fiber coupler type where an optical circuit is configured solely by optical fibers, or a planary waveguide type where an optical circuit is configured by planary waveguides.

In other respect, the present invention may be modified without departing the inventive concept thereof.

What is claimed is:

1. A wavelength monitoring device, comprising:
deinterleaver means for separating a multi-wavelength optical signal comprised of densely spaced channel signals into plural channel signal groups in accordance with their wavelength, each channel signal group being comprised of low-densely spaced channel signals; and
a plurality of wavelength monitoring circuits individually corresponding to the plural channel signal groups, each circuit being arranged to separate the channel signal group associated therewith into individual channel signals and detect a wavelength-related parameter of each channel signal.

2. The wavelength monitoring device according to claim 1, wherein each of said wavelength monitoring circuits detects, as the wavelength-related parameter, at least one of central wavelength and intensity of each channel signal.

3. The wavelength monitoring device according to claim 1, wherein said deinterleaver means includes a first deinterleaver for separating the multi-wavelength optical signal into a first channel signal group comprised of odd channel signals and a second channel signal group comprised of even channel signals.

4. The wavelength monitoring device according to claim 3, wherein said first deinterleaver includes a circulator having a first port for receiving the multi-wavelength optical signal, a second port to which a filter for delivering the first channel signal group is connected, and a third port for delivering the second channel signal groups.

5. The wavelength monitoring device according to claim 1, wherein said deinterleaver means is comprised of a first deinterleaver for separating the multi-wavelength optical signal into channel signal groups and N deinterleaver stages,
each deinterleaver stage is comprised of a plurality of second deinterleavers, and
each second deinterleaver is configured to separate a channel signal group into plural subsidiary channel signal groups.

6. The wavelength monitoring device according to claim 5, wherein said first deinterleaver separates the multi-wavelength optical signal into first and second channel signals,
said each deinterleaver stage is comprised of an even number of second deinterleavers,
each second deinterleaver is configured to separate a channel signal group, received at its input terminal, into two subsidiary channel signal groups and deliver these two subsidiary channel signal groups from its two output terminals, respectively, and
the input terminal of each second deinterleaver is connected to one of the output terminals of a corresponding one of the second deinterleavers constituting the deinterleaver stage immediately upstream of said each second deinterleaver or connected to one of the output terminals of the first deinterleaver.

7. The wavelength monitoring device according to claim 6, wherein each second deinterleaver includes a circulator having a first port serving as the input terminal, a second port to which a filter serving as one of the two output terminals is connected, and a third port serving as another output terminal.

8. The wavelength monitoring device according to claim 1, wherein said each wavelength monitoring circuit has a wavelength-division demultiplexing filter for demultiplexing the channel signal group associated therewith into individual channel signals and a photodetector array comprised of plural photodetector groups, and
each photodetector group is comprised of plural photodetectors that are arranged to receive wavelength components of a corresponding one of the individual channel signals.

9. A wavelength monitoring device, comprising:
deinterleaver means for separating a multi-wavelength optical signal comprised of densely spaced channel signals into plural channel signal groups in accordance with their wavelength, each channel signal group being comprised of low-densely spaced channel signals;
at least one optical switch for alternately selecting at least two channel signal groups; and
at least one wavelength monitoring circuit for separating the channel signal group, selected by the optical switch, into individual channel signals and for detecting a wavelength-related parameter of each channel signal.

10. The wavelength monitoring device according to claim 9, wherein said wavelength monitoring circuit detects, as the wavelength-related parameter, at least one of central wavelength and intensity of each channel signal.

11. The wavelength monitoring device according to claim 9, wherein said deinterleaver means includes a first deinterleaver for separating the multi-wavelength optical signal into a first channel signal group comprised of odd channel signals and a second channel signal group comprised of even channel signals.

12. The wavelength monitoring device according to claim 11, wherein said first deinterleaver includes a circulator having a first port for receiving the multi-wavelength optical signal, a second port to which a filter for delivering the first channel signal group is connected, and a third port for delivering the second channel signal groups, respectively.

13. The wavelength monitoring device according to claim 11, wherein said deinterleaver means is comprised of a first deinterleaver for separating the multi-wavelength optical signal into channel signal groups and N deinterleaver stages,
each deinterleaver stage is comprised of a plurality of second deinterleavers, and
each second deinterleaver is configured to separate a channel signal group into plural subsidiary channel signal groups.

14. The wavelength monitoring device according to claim 13, wherein said first deinterleaver separates the multi-wavelength optical signal into first and second channel signal groups,
said each deinterleaver stage is comprised of an even number of second deinterleavers,
each second deinterleaver is configured to separate a channel signal group, received at its input terminal, into two subsidiary channel signal groups and deliver these two subsidiary channel signal groups from its two output terminals, respectively, and
the input terminal of each second deinterleaver is connected to one of the output terminals of a corresponding one of the second deinterleavers constituting the deinterleaver stage immediately upstream of said each second deinterleaver or connected to one of the output terminals of the first deinterleaver.

15. The wavelength monitoring device according to claim 14, wherein said each second deinterleaver includes a circulator having a first port serving as the input terminal, a second port to which a filter serving as one of the two output terminals is connected, and a third port serving as another output terminal.

16. The wavelength monitoring device according to claim 9, wherein said each wavelength monitoring circuit has a wavelength-division demultiplexing filter for demultiplexing the channel signal group associated therewith into individual channel signals and a photodetector array comprised of plural photodetector groups, and
each photodetector group is comprised of plural photodetectors that are arranged to receive wavelength components of a corresponding one of the individual channel signals.
